(19) United States
(12) Patent Application Publication
(10) Pub. No.: US 2013/0160313 A1
(43) Pub. Date: Jun. 27, 2013

(54) OFFSET MEASURER

(71) Applicant: Patrick Swanson, Chattanooga, TN (US)

(72) Inventor: Patrick Swanson, Chattanooga, TN (US)

(21) Appl. No.: 13/333,230

(22) Filed: Dec. 21, 2011

(51) Int. Cl. B43L 7/10

(52) U.S. Cl. 33/430

(57) ABSTRACT

A measurement apparatus for measuring levels and plumb of items with offset dimensions comprises a base, a cross member, and a slide bracket. The cross member may have a shaft and a slide. The shaft may be rotatable around the base. The slide may move along on the shaft. The slide bracket may be connected to the base and the shaft. The cross member and the slide bracket may be slidable inside the slot of the base.

### BACKGROUND OF THE INVENTION

The present invention generally relates to the field of measurement tools, and more specifically relates to an apparatus of finding measurements, levels, and plumbness of items with offset dimensions.

Offset measurements between components of various heights, length's, widths, and angles may be needed during installation or repair depending items being measured. Sometimes when it comes to measure air duct elbows, for example, users have to guess a level or plumbness of the air duct elbows with offset dimensions.

Therefore, there is a need for a measurement apparatus of accurate measurement, level, and plumbness of an object.

### SUMMARY OF THE INVENTION

In one aspect of the present invention, a measurement apparatus comprises a base, a cross member having a shaft and a slide, wherein the slide moves along on the shaft, wherein the shaft is rotatable around the base; and a slide bracket connected to the base and the vertical shaft, wherein the base has a slot adapted to receive at least part of the slide bracket, wherein the cross member and the slide bracket are slidable inside the slot of the base.

In another aspect of the present invention, a measurement apparatus comprises a base having a slot a slide bracket having an end adapted to insert into the slot, wherein the slide bracket is slidable inside the horizontal slot; an adjustable locking angle finder connected to the slide bracket; and a shaft adapted to connect to the slide bracket via the adjustable locking angle finder, wherein the shaft has graduation markings along the shaft.

These and other features, aspects and advantages of the present invention will become better understood with reference to the following drawings, description and claims.

### BRIEF DESCRIPTION OF THE DRAWINGS

FIG. 1 is a perspective view of a measuring apparatus according to an exemplary embodiment of the present invention;

FIG. 2 is a side view of a measuring apparatus according to the exemplary embodiment of the present invention shown in FIG. 1;

FIG. 3 is a front view of a measuring apparatus according to the exemplary embodiment of the present invention shown in FIG. 1;

FIG. 4 a perspective view of a measuring apparatus according to the exemplary embodiment of the present invention illustrating a range of motion of a top horizontal slide;

FIG. 5 is a perspective view of a measuring apparatus according to the exemplary embodiment of the present invention illustrating a horizontal range of motion of a shaft;

FIG. 6 is a perspective view of a measuring apparatus according to the exemplary embodiment of the present invention illustrating rotational range of motion of the shaft; and

FIG. 7 is a perspective view of a measuring apparatus according to the exemplary embodiment of the present invention illustrating rotational range of motion of the shaft.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a method and an apparatus of finding measurements, levels, and plumbness of items with offset dimensions.

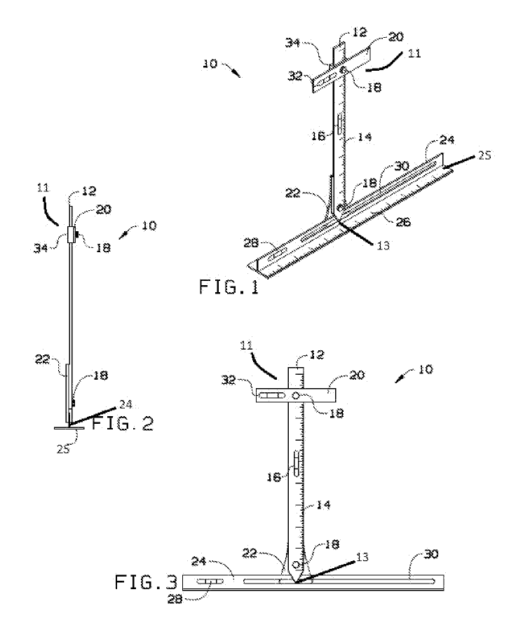

As shown in FIGS. 1-3, in an exemplary embodiment of the present invention, the measurement apparatus 10 may have a base 24 and a flange 25. The base 24 may have a slot 30, and a level 28. The level 28 may be a spirit level or bubble level which may be designed to indicate whether a surface is horizontal or vertical relative to the base 24, for example. The flange 25 may be coupled to the base 24 and may be oriented substantially perpendicular to the base 24. On the surface of the flange 26, there may be graduation markings 26 that indicate linear measurement. Alternatively, there may be angle measurement on the surface of the flange 26.

The slot 30 may be adapted to receive an end of a slide bracket 22. The slide bracket 22 may be movable along the track inside the horizontal slot 30. A cross member 11 may have a shaft 12 and a slide 20 which may be orthogonal to the shaft 12. The shaft 12 may extend orthogonally from the flange 25, planar to the base 24. The slide 20 may have a slide bracket 34, and an adjustable locking angle finder 18. The slide 20 may move along on the shaft 12. The adjustable locking angle finder 18 may be used to lock the slide 20 to the shaft 12.

On the surface of the shaft 12, there may be graduation markings 14 that indicate linear measurement. The shaft 12 may include an adjustable locking angle finder 18, which may be used to connect the vertical shaft 12 to the slide bracket 22. The shaft 12 may have a pointed end 13 that may point to the graduation markings 26, for example, on the surface of the flange 26. The shaft 12 and the slide 20 may further include a level 16, 32 respectively. The level 16 may be oriented along the graduation markings 14. The level 32 may be oriented along the elongated slide 20 and orthogonal to the shaft 12.

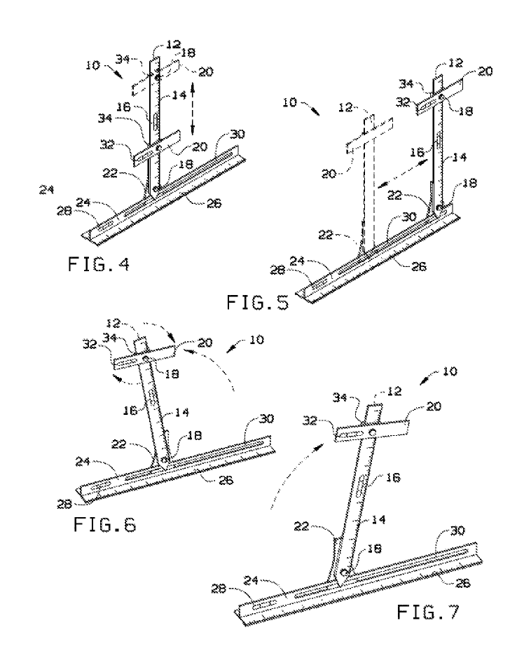

In operation of an exemplary embodiment, FIGS. 4-7 show linear or rotational movement of the shaft 12 and slide 20 of an exemplary embodiment of the present invention. For example, the slide 20 may be movable up or down along the shaft 12 as shown in FIG. 4. The shaft 12, together with the slide 20, may be linearly movable along the track of the slot 30 on the base 24 as shown in FIG. 5.

As shown in FIGS. 6-7, the horizontal slide 20 may be rotatable about a center axis of the adjustable locking angle finder 18. The slide 20, together with the shaft 12, may be rotatable about the adjustable locking angle finder 18.

To use the exemplary embodiment of the present invention, the shaft 12 may be placed against the back of an item that users want the height, plumb, and level. The slide 20 may be used to slide, tilt, and adjust the level of the offset item that is placed against the shaft. The base 24 may be used to find the depth of the offset item.

The exemplary embodiment of the present invention may be used in various objects, such as, offset air ducts, cars, instruments, buildings, and furniture, for example.

It should be understood, of course, that the foregoing relates to exemplary embodiments of the invention and that modifications may be made without departing from the spirit and scope of the invention as set forth in the following claims.

We claim:

1. A measurement apparatus, comprising:
a base;
a cross member having a shaft and a slide, wherein the slide moves along on the shaft, wherein the shaft is rotatable around the base; and
a slide bracket connected to the base and the shaft, wherein the base has a slot adapted to receive at least part of the slide bracket, wherein the cross member and the slide bracket are slidable inside the slot of the base.

2. The measurement apparatus of claim 1, wherein the shaft has graduation markings along surface of the shaft.

3. The measurement apparatus of claim 1, wherein each of the base, the shaft, and the slide has a level.

4. The measurement apparatus of claim 1, wherein the base has a flange coupled to the base, wherein the flange is oriented substantially perpendicular to the base.

5. The measurement apparatus of claim 1, wherein the slide has an adjustable locking angle finder adapted to connect to the shaft.

6. The measurement apparatus of claim 1, wherein the shaft has an adjustable locking angle finder adapted to connect to the slide bracket.

7. A measurement apparatus, comprising:
a base having a slot;
a slide bracket having an end adapted to insert into the slot, wherein the slide bracket is slidable inside the slot;
an adjustable locking angle finder connected to the slide bracket;
and a shaft adapted to connect to the slide bracket via the adjustable locking angle finder, wherein the shaft has graduation markings along the shaft.

8. The measurement apparatus of claim 7, further comprising a flange coupled to the base, wherein the flange is oriented substantially perpendicular to the base.

9. The measurement apparatus of claim 7, further comprising a slide wherein the slide moves along on the vertical shaft.

10. The measurement apparatus of claim 7, wherein the vertical shaft is rotatable around a center axis of the adjustable locking angle finder.
